(19) United States
(12) Patent Application Publication
(10) Pub. No.: US 2009/0162642 A1
(43) Pub. Date: Jun. 25, 2009

(54) PAPER CONTAINING PREGGREGATED FILLER AND PROCESS FOR PRODUCING THE SAME

(76) Inventors: Katsumasa Ono, Tokyo (JP); Koji Kutsuwa, Tokyo (JP); Tomohiro Yokohara, Tokyo (JP); Fuminari Nonomura, Tokyo (JP); Masayuki Watanabe, Tokyo (JP); Hiroshi Koyamoto, Tokyo (JP); Akinobu Chatani, Tokyo (JP); Yoshiharu Kimura, Hyogo (JP); Takao Sezaki, Hyogo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 12/162,325

(22) PCT Filed: Jan. 26, 2007
(86) PCT No.: PCT/JP2007/051247

§ 371 Date: Sep. 18, 2008

(30) Foreign Application Priority Data
Jan. 26, 2006 (JP) 2006-017997
Feb. 27, 2006 (JP) 2006-050930
Feb. 27, 2006 (JP) 2006-050931
Mar. 10, 2006 (JP) 2006-064981

(51) Int. Cl. B32B 5/16; D21H 17/33

(52) U.S. Cl. 428/330; 428/323; 162/164.6

(57) ABSTRACT

Provide a paper offering good paper strength properties in terms of strength and stiffness, high smoothness and excellent printing quality by adjusting the ash content in paper to a range of 3 to 40 percent by solid weight and allowing the paper to contain a pre-coagulated filler having an average particle size of 10 to 80 μm as measured by the laser diffraction method, wherein such filler is obtained by processing a filler using a composite acrylamide copolymer comprising (A) an anionic polysaccharide and (B) a cationic and/or amphoteric acrylamide copolymer.

### TECHNICAL FIELD

The present invention relates to a paper added with a pre-coagulated filler, such as a newsprint paper, clear coated printing paper, electronic photograph transfer paper or coated paper for printing, and a method of manufacturing the same.

### PRIOR ART

Traditionally, various types of papers have been used for various different purposes. Examples include newsprint papers, clear coated printing papers, electronic photograph transfer papers, and coated papers for printing, among others.

As for newsprint papers, the most important quality is the ability to withstand high-speed mass printing, and requirements on tensile strength to prevent tearing are extremely high. In particular, the recent trends in the industry to use lighter papers, and papers containing higher contents of recycled paper pulp such as deinked pulp, are resulting in lower paper strength.

Also, problems caused by accumulation of paper dust, such as blurred printed surface, are also becoming increasingly important because a large number of copies are printed over a short period of time. In addition to the traditional quality requirements for printing papers relating to their traveling performance, requirements for print quality are also increasing each year of late now that more pages are printed in color.

One new technology relating to newsprint papers that has been developed in recent years is neutral newsprint papermaking. Aimed at providing a neutral newsprint paper having levels of strength, opacity, resin retention and wear resistance of offset printing plates equivalent to or better than those of acid newsprint papers, a neutral newsprint paper containing 5 to 15 percent by weight of calcium carbonate as a filler is disclosed along with a method of manufacturing such paper. However, there is no mention of effective countermeasures to prevent decrease in paper strength caused by an increase in the added content of calcium carbonate (Refer to Patent Literature 1). With a paper containing a large amount of calcium carbonate or other filler, the pulp content becomes relatively low and the filler inhibits hydrogen bonding between pulp fibers. As a result, paper strength tends to decreases drastically.

Clear coated printing papers made by coating a base paper with a clear coating solution whose primary components are surface paper strength agent, etc., or coated papers for printing made by providing on a base paper a coating layer whose primary components are pigment and adhesive, are often used on offset presses. Accordingly, the most important quality required of these papers is the ability to withstand use on offset presses, and specifically requirements on surface strength to prevent problems caused by paper dust and those on interlayer strength to prevent delamination are extremely high. In addition, the recent trends for higher filler content and higher content of recycled paper pulp are resulting in lower paper strength.

For example, an effective way to improve the print surface of a clear coated printing paper is to increase the ash content in paper. Increasing the ash content in paper has the effect of improving the smoothness of the base paper. However, the higher ash content presents a different set of problems such as a higher amount of paper dust generating in the offset press and higher chances of delamination problems occurring as a result of decrease in interlayer strength. With coated papers for printing, a decrease in the interlayer strength of the base paper is a cause of blistering (a phenomenon where the paper surface is pushed up from inside due to evaporation of moisture content in the paper and thereby blisters form partially) on heat-setting type offset rotary presses where ink is dried by means of heat.

As with clear coated printing papers and coated papers for printing, electronic photograph transfer papers have also been prone to a decrease in paper strength and consequently a delamination phenomenon called “peeling” while being transferred in a copier due to higher filler content and higher content of recycled paper pulp.

As for electronic photograph transfer papers, the ability to withstand use on copiers adopting the electronic photograph printing method or on laser beam printers, etc., is the most important quality required of these papers, and specifically requirements on resistance to curling after copying and those on bending stiffness to prevent paper jam are extremely high. Since the printing time is becoming longer in recent years, problems associated with accumulation of paper dust, such as problems of printed images, are also becoming increasingly important.

To improve the print surface of an electronic photograph transfer paper, increasing the ash content in paper is effective, just like it is in improving the print surface of a clear coated printing paper. Increasing the ash content in paper has the effect of improving the smoothness and reducing the curling after copying. With an electronic photograph transfer papers, however, a higher ash content reduces the strength, especially interlayer strength, of the paper and thereby results in various problems such as frequent peeling while the paper is being transferred through a copier, increased amount of paper dust generating in a copier, and frequent occurrences of paper jam due to decrease of bending stiffness.

Among the technologies to cause more filler to remain in the paper while minimizing the decrease in paper strength, are the following technologies intended to cause a filler to coagulate beforehand and then add this coagulated filler to the paper stuff. For example, a method of manufacturing a paper is disclosed with the aim of providing a method of manufacturing a paper using an inexpensive, general white pigment comprising fine particles to efficiently increase the scattering coefficient to make a paper offering good retention on the paper layer and minimizing the decrease in paper strength or stiffness, wherein such method is characterized in that the base particles of a pigment with a refraction factor of 1.45 to 1.65 are coagulated to form many internal voids and the obtained coagulated particles of the pigment are added to a pulp slurry to make a paper. Calcium carbonate, kaolin, anhydrous calcium sulfate, plaster, calcium sulfite, calcium silicate, barium sulfate, talc and silicious marl are cited as examples of the pigment, while the coagulation methods include adjusting pH using an acid or alkali, using an inorganic coagulant such as aluminum sulfate, and adding an organic polymer coagulant. However, this technology is designed to make adjustments so that internal voids whose diameter is 0.1 μm or more but preferably having sizes as close as possible to 0.1 μm are formed in a large number, and such adjustments are difficult to make (refer to Patent Literature 2).

Next, a paper product with filler containing 5 to 80 percent by weight of coagulated particles relative to the dry pulp is disclosed, together with a method of manufacturing such paper product, with the aim of using inexpensive calcium carbonate to provide a paper product and method of manufacturing such paper product where such paper offers efficiently improved opacity, good retention in the paper layer, and minimum decrease in paper strength or stiffness. Here, such paper provides a paper product mainly comprising pulp and calcium carbonate, made by coagulating particles of the calcium carbonate having a particle size of 0.1 to 0.3 μm and causing the coagulated particles to be contained by 5 to 80 percent by weight relative to the dry pulp. The coagulation methods include adjusting pH using an acid or alkali, using an inorganic coagulant such as aluminum sulfate, and adding an organic polymer coagulant. However, this technology requires dewatering and drying in order to stabilize the diameters of coagulated particles, and this requirement makes this method not practical (refer to Patent Literature 3).

Another papermaking method using ground calcium carbonate as a papermaking filler is disclosed with the aim of providing a papermaking method that significantly improves the problem of worn wires of the papermaking machine caused by use of ground calcium carbonate as a papermaking filler, wherein specifically the ground calcium carbonate is mixed with an aqueous solution of cation denatured starch and then the mixture is added to the paper stuff (refer to Patent Literature 4).

Among the methods of manufacturing a paper mainly using pulp and calcium carbonate filler, a method of manufacturing a paper containing filler is disclosed, wherein cationized starch and cationized guar gum are used as coagulants to coagulate a filler, or aluminum sulfate, polychlorinated aluminum or other inorganic coagulant is used to coagulate a filler and then cationized starch and cationized guar gum are used to achieve further coagulation of the filler, after which 1 to 50 percent by weight of the coagulated particles are added to the paper. However, use of a single ionic chemical agent means that the charge balance of the processing system is determined only by the amount of the processing agent and therefore the range of conditions achieving optimal processing in terms of charge balance becomes narrow. As a result, deviation from these conditions presents the problem of deteriorating adsorption efficiency of the processing agent to the filler (refer to Patent Literature 5).

Another method of manufacturing a paper is disclosed wherein a pre-coagulated filler is added to a complete paper stuff (especially complete paper stuff for newsprint paper) containing 30% or more of ground pulp, recycled pulp or other low-grade pulp relative to the overall pulp. As for this filler, clay, china clay, lithopone, sulfate filler, titanium pigment, titanium dioxide, satin white, talc, calcium carbonate, barium sulfate, plaster and whiting chalk are cited as examples, among others. As for the coagulant, water-soluble vinyl polymer, gum, aluminum sulfate, mannogalactan, anionic starch derivative and cationic starch derivative are cited as examples, among others. However, means for making sure the required paper strength is sufficiently met, or effective means for preventing a decrease in surface strength due to coagulation of the filler, are not described (refer to Patent Literature 6).

Also, chemicals such as starch, polyacrylamide (hereinafter abbreviated as “PAM”) and other paper-strength enhancing agents are generally used to compensate for a decrease in paper strength due to higher filler content. However, the amounts of chemicals to be added must be increased in order to achieve a greater effect of improving paper strength, and this leads to problems such as dirty marks.

Also, a paper containing filler is known where such paper specifically contains a coated filler produced by coating a filler with a composite acrylamide copolymer (composite PAM) comprising an anionic polysaccharide and a cationic and/or amphoteric acrylamide copolymer (refer to Patent Literature 7). However, the strength of this paper is not sufficient when the ash content is increased, and satisfactory quality has not been achieved in terms of perceived quality of print surface.

### Patent Literature 1: Japanese Patent No. 2889159

Patent Literature 2: Japanese Patent Laid-open No. Sho 54-050605
Patent Literature 3: Japanese Patent Laid-open No. Sho 54-116405
Patent Literature 4: Japanese Patent Laid-open No. Sho 60-119299
Patent Literature 5: Japanese Patent Laid-open No. Hei 10-060794

### Patent Literature 6: Japanese Patent Laid-open No. 2000-129589

Patent Literature 7: International Patent Laid-open No. WO2006/100996

### SUMMARY OF THE INVENTION

### Problems to Be Solved by the Invention

According to prior art, no means are available for making sure the required paper strength is sufficiently met, nor effective means for preventing a decrease in surface strength due to coagulation of the filler. Chemicals such as starch, polyacrylamide (hereinafter abbreviated as “PAM”) and other paper-strength enhancing agents are generally used to compensate for a decrease in paper strength due to higher filler content. However, the amounts of chemicals to be added must be increased in order to achieve greater effect of improving paper strength, and this leads to problems such as dirty marks.

In light of the aforementioned problems, it is an object of the present invention to provide a paper offering good stiffness and strength as well as high smoothness. It is another object of the present invention to provide a coated paper for printing subject to less blistering and generation of paper dust during printing on offset presses, and also offering high smoothness as well as good printing quality, which paper is an electronic photograph transfer paper causing less tearing or generating less paper dust during offset printing and also offering excellent printing quality, and further reducing delamination and generation of paper dust when used on offset presses due to improved paper strength, and eliminating paper jam, peeling or generation of paper dust while being transferred through a copier due to improved stiffness and paper strength, and also reducing generation of paper dust when used on copiers or laser printers.

### Means for Solving the Problems

One object of the present invention is to provide a paper having good paper strength properties in terms of strength and stiffness, offering high smoothness, and exhibiting excellent printing quality.

According to an embodiment of the present invention aimed at achieving the aforementioned object, a paper with an ash content in paper of 3 to 40 percent by solid weight and containing a pre-coagulated filler having an average particle size of 10 to 80 μm as measured by the laser diffraction method is provided, wherein such filler is obtained by processing a filler using a composite acrylamide copolymer comprising (A) an anionic polysaccharide and (B) a cationic and/or amphoteric acrylamide copolymer.

According to another embodiment, a neutral newsprint paper for offset printing is provided, wherein such paper is obtained by coating a surface treatment agent over a paper with an ash content in paper of 3 to 40 percent by solid weight and containing a pre-coagulated filler having an average particle size of 10 to 80 μm as measured by the laser diffraction method, and wherein such filler is obtained by processing a filler using a composite acrylamide copolymer comprising (A) an anionic polysaccharide and (B) a cationic and/or amphoteric acrylamide copolymer. According to this embodiment, a neutral newsprint paper causing less tearing or generating less paper dust during offset printing and also offering excellent printing quality can be provided. According to yet another embodiment, a clear coated printing paper is provided, wherein such paper is obtained by coating a surface treatment agent over a paper with an ash content in paper of 3 to 40 percent by solid weight and containing a pre-coagulated filler having an average particle size of 10 to 80 μm as measured by the laser diffraction method, and wherein such filler is obtained by processing a filler using a composite acrylamide copolymer comprising (A) an anionic polysaccharide and (B) a cationic and/or amphoteric acrylamide copolymer. According to this embodiment, a clear coated printing paper reducing delamination and generation of paper dust when used on offset presses due to improved paper strength, and also offering excellent printing quality, can be provided.

According to yet another embodiment, an electronic photograph transfer paper with an ash content in paper of 3 to 40 percent by solid weight and containing a pre-coagulated filler having an average particle size of 10 to 80 μm as measured by the laser diffraction method is provided, wherein such filler is obtained by processing a filler using a composite acrylamide copolymer comprising (A) an anionic polysaccharide and (B) a cationic and/or amphoteric acrylamide copolymer. According to this embodiment, an electronic photograph transfer paper eliminating paper jam, peeling or generation of paper dust while being transferred through a copier due to improved stiffness and paper strength, and also reducing generation of paper dust when used on copiers or laser beam printers, can be provided.

According to yet another embodiment, a coated paper for printing is provided, wherein such paper is obtained by providing a coating layer containing pigment and adhesive on a paper with an ash content in paper of 3 to 40 percent by solid weight and containing a pre-coagulated filler having an average particle size of 10 to 80 μm as measured by the laser diffraction method, and wherein such filler is obtained by processing a filler using a composite acrylamide copolymer comprising (A) an anionic polysaccharide and (B) a cationic and/or amphoteric acrylamide copolymer. According to this embodiment, a coated paper for printing subject to less blistering and generation of paper dust during printing on offset presses, and also offering high smoothness as well as good printing quality, can be provided.

### EFFECTS OF THE INVENTION

A neutral newsprint paper for offset printing according to the present invention, which is obtained by coating a surface treatment agent over a paper with an ash content in paper of 3 to 40 percent by solid weight and containing a pre-coagulated filler having an average particle size of 10 to 80 μm as measured by the laser diffraction method, wherein such filler is obtained by processing a filler using a composite acrylamide copolymer comprising (A) an anionic polysaccharide and (B) a cationic and/or amphoteric acrylamide copolymer, provides a neutral newsprint paper causing less tearing or generating less paper dust during offset printing and also offering excellent printing quality. The present invention also provides a coated paper for printing subject to less blistering and generation of paper dust during printing on offset presses, and also offering high smoothness as well as good printing quality, which paper is also an electronic photograph transfer paper reducing delamination and generation of paper dust when used on offset presses due to improved paper strength, and eliminating paper jam, peeling or generation of paper dust while being transferred through a copier due to improved stiffness and paper strength, and also reducing generation of paper dust when used on copiers or laser beam printers.

### BEST MODE FOR CARRYING OUT THE INVENTION

### (Pulp Material)

The pulp material of a paper manufactured according to the present invention is not specifically limited, and any pulp material generally used as a papermaking material can be used, such as ground pulp (GP), thermo-mechanical pulp (TMP), chemi-thermo-mechanical pulp (CTMP), deinked pulp (DIP) or softwood kraft pulp (NKP). These pulps may be used alone or in combination.

### (Pre-Coagulated Filler)

After examining different combinations of fillers and processing agents, the inventors found that an optimal processing agent to be combined with a filler would be a composite acrylamide copolymer (hereinafter referred to as “composite PAM”) comprising (A) an anionic polysaccharide and (B) a cationic and/or amphoteric acrylamide copolymer (hereinafter referred to as “PAM”). One reason for this is that because a composite PAM comprises (A) an anionic polysaccharide and (B) a cationic and/or amphoteric PAM, each having different characteristics in terms of ionicity and polymer structure; the polysaccharide provides the anionic property and a spreading structure of high molecular weight, while the PAM has cationic property and hydecreasehilic characteristics; and consequently a polyion complex having both the aforementioned structure and characteristics can be obtained. As a result, an appropriate coagulation effect relative to the filler particles can be demonstrated along with a high affinity with the pulp slurry. The method of adding a pre-coagulated filler to a paper stuff improves the filler retention significantly because the filler is coagulated in advance and the coagulated filler is less vulnerable to the undesirable effects of anionic substances in the paper stuff.

Also when additive chemicals such as cationic starch and PAM-type paper-strength enhancing agent are added to a pulp slurry containing a filler that has been processed with a composite PAM, synergistic effects can be achieved from both the filler and chemicals without inhibiting their respective positive effects, and therefore the paper strength can be improved more effectively with smaller amounts of chemicals.

In other words, a coated filler processed with a composite PAM combining two components having different charge characteristics provides an appropriate coagulation effect and achieves excellent affinity with the pulp slurry, or provides good compatibility with the chemicals added to the pulp slurry, and consequently the paper strength can be enhanced to a great extent even when the filler content is high and the amounts of added chemicals are small (such as 0.01 to 0.6 percent by weight relative to the base paper).

Filler

As the filler to be pre-coagulated, any know filler can be used. Examples include precipitated calcium carbonate, ground calcium carbonate, clay, calcined clay, silicious marl, talc, kaolin, calcined kaolin, delaminated kaolin, magnesium carbonate, barium carbonate, titanium dioxide, zinc oxide, silicon oxide, amorphous silica, aluminum hydroxide, calcium hydroxide, magnesium hydroxide, zinc hydroxide and other inorganic fillers, as well as urea-formalin resin, polystyrene resin, phenol resin and fine hollow particles. One or more of the above fillers can be used, but a preferred filler is calcium carbonate, while a more preferred filler is precipitated calcium carbonate, because these fillers can demonstrate a more appropriate coagulation effect and greater affinity with the pulp slurry.

Furthermore, the shape of precipitated calcium carbonate should preferably be Rosetta, rhombohedral or prismatic. The average particle size should preferably be in a range of 0.1 to 20 μm (including ranges of 0.5 to 10 μm and 1 to 5 μm), while the relative surface area should preferably be in a range of 3 to 20 m² (including a range of 5 to 12 m²).

Average Particle Size

The average particle size of the pre-coagulated filler affects the paper strength and amount of paper dust, among others. For example, the average particle size can be in a range of 10 to 80 μm, but it should preferably be in a range of 20 to 60 μm, or more preferably in a range of 25 to 55 μm. If the coagulation level is low and the average particle size is less than 10 μm, the paper strength becomes weaker. If the coagulation level is high and the average particle size exceeds 80 μm, on the other hand, there will not be any problem with paper strength but the brightness may decrease or amount of paper dust may increase. For your information, average particle sizes mentioned in connection with the present invention refer to values measured by the laser diffraction method.

Processing Agent

A composite PAM used under the present invention comprises (A) an anionic polysaccharide and (B) a cationic and/or amphoteric PAM. In this case, substances that can be used as the component (B) do not include anionic PAMs.

The anionic polysaccharide (A) functions as an acid substituent group, and starches, alginic acids, celluloses, gums and other derivatives to which a carboxyl group, sulfate group or sulfonate group has been introduced may be used alone or in combination. For the specific method to manufacture an anionic polysaccharide, an anionization agent such as chloroacetic acid can be reacted with any of various polysaccharides to manufacture a polysaccharide having a carboxyl group, etc. Commercially available anionic polysaccharides include carboxymethyl celluloses (carboxymethyl celluloses and salts thereof; hereinafter referred to as “CMCs”), alginic acids (alginic acids and salts thereof), xanthan gum, carboxymethyl guar gum, phosphorylated guar gum, carboxymethyl starch, and phosphoric acid starch, among others. Under the present invention, this anionic polysaccharide should preferably be a CMC or alginic acid.

As for the component (B), examples of the amphoteric acrylamide copolymer (referred to as “amphoteric PAM” as a matter of convenience) include those comprising (a) a meth(acrylamide), (b) a cationic monomer, and (c) an anionic monomer (the average molecular weight of the copolymer may be in a range of 200,000 to 4 million, for example). Examples of the (meth)acrylamide (a) include acrylamide (abbreviated as “AM”) and/or methacrylamide.

The cationic monomer (b) has one or more cation groups in the molecule, such as primary to tertiary amino group-containing (meth)acrylamides, primary to tertiary amino group-containing (meth)acrylates, quaternary ammonia base-containing (meth)acrylamides, quaternary ammonia base-containing (meth)acrylates, and diaryl dialkyl ammonium halides. For example, compounds represented by general formula (I) below are representative examples of quaternary ammonium base-containing monomers.

[CH₂═C(R₁)—CO-A-R₂—N⁺(R₃)(R₄)(R₅)]X⁻ (1)

(In the formula (I), R₁ indicates H or CH₃; R₂ indicates an alkylene group of C₁ to C₃; R₃, R₄ and R₅ each indicate H, an alkyl group of C₁ to C₃, benzyl group or CH₂CH(OH)CH₂N⁺(CH₃)₃X⁻, where R₃, R₄ and R₅ may be different substances, respectively, or all of them may be the same substance; A indicates O or NH; and X indicates an anion such as halogen or alkyl sulfate.)

Preferred examples of this cationic monomer (b) include primary to tertiary amino group-containing (meth)acrylamides, primary to tertiary amino group-containing (meth)acrylates, quaternary ammonia base-containing (meth)acrylamides and quaternary ammonia base-containing (meth)acrylate.

The primary and secondary amino group-containing (meth)acrylamides include primary amino group-containing (meth)acrylamides such as aminoethyl (meth)acrylamides, and secondary amino group-containing (meth)acrylamides such as methyl aminoethyl (meth)acrylamides, ethyl aminoethyl (meth)acrylamides and t-butyl aminoethyl (meth)acrylamides. Representative examples of the tertiary amino group-containing (meth)acrylamides include dimethyl aminoethyl (meth)acrylamides, dimethyl aminopropyl (meth)acrylamides (dimethyl aminopropyl acrylamide is abbreviated as “DMAPAA”), diethyl aminoethyl (meth)acrylamides, diethyl aminopropyl (meth)acrylamides and other dialkyl aminoalkyl (meth)acrylamides.

The primary and secondary amino group-containing (meth)acrylates include aminoethyl (meth)acrylates and other primary amino group-containing (meth)acrylates, and methyl aminoethyl (meth)acrylates, ethyl aminoethyl (meth)acrylates, t-butyl aminoethyl (meth)acrylates and other secondary amino group-containing (meth)acrylates. Representative examples of the tertiary amino group-containing (meth)acrylates include dimethyl aminoethyl (meth)acrylates (dimethyl aminoethyl (meth)acrylate is abbreviated as “DM”), dimethyl aminopropyl (meth)acrylates, diethyl aminoethyl (meth)acrylates, diethyl aminopropyl (meth)acrylates and other dialkyl aminoalkyl (meth)acrylates.

The quaternary ammonium base-containing (meth)acrylamides or quaternary ammonium base-containing (meth)acrylates are mono quaternary base-containing monomers produced by using a tertiary ammonium base-containing (meth)acrylamide or tertiary ammonium base-containing (meth)acrylate together with a quaternization agent such as methyl chloride, benzyl chloride, methyl sulfate or epichlorohydrin. Examples include acrylamide propyl benzyl dimethyl ammonium chloride, methacryloyloxyethyl dimethyl benzyl ammonium chloride (abbreviated as “DMBQ”), acryloyloxyethyl dimethyl benzyl ammonium chloride, (meth)acryloyl aminoethyl trimethyl ammonium chloride, (meth)acryloyl aminoethyl triethyl ammonium chloride, (meth)acryloyloxyethyl trimethyl ammonium chloride and (meth)acryloyloxylethyl triethyl ammonium chloride, among others.

As for the cationic monomer (b), a bis quaternary base-containing monomer having two quaternary ammonium bases in the molecule can be used in order to obtain a high molecular weight. Specific examples include bis quaternary base-containing (meth)acrylamides or bis quaternary base-containing (meth)acrylates having two quaternary ammonium bases. Examples of bis quaternary base-containing (meth)acrylamides include bis quaternary base-containing (meth)acrylamides obtained by reacting a dimethyl aminopropyl acrylamide with a 1-chloro-2-hydroxypropyl trimethyl ammonium chloride (abbreviated as “DMAPAA-Q2”). This DMAPAA-Q2 corresponds to a compound conforming to the aforementioned general formula (I) for cationic monomer where R₁ is H, R₂ is a propylene group, A is NH, R₃ and R₄ are each a methyl group, R₅ is CH₂CH(OH)CH₂N⁺(CH₃)₃C⁻, and X is chlorine.

On the other hand, diaryl dialkyl ammonium halide belonging to the aforementioned group of quaternary ammonium base-containing cationic monomers (b) may be, for example, diaryl dimethyl ammonium chloride.

The anionic monomer (c) being a component of the amphoteric PAM is an α or β-unsaturated carbonic acid, or α or β-unsaturated sulfonic acid, among others.

Examples of the unsaturated carbonic acid include (meth)acrylic acids (acrylic acid is abbreviated as “AA”), maleic acids (maleic acid anhydrides), fumaric acids, itaconic acids (abbreviated as “IA”) and citraconic acids (citraconic acid anhydrides), as well as sodium, potassium or ammonium salts thereof.

Examples of the unsaturated sulfonic acid include vinyl sulfonic acids, (meth)allyl sulfonic acids, styrene sulfonic acids, sulfopropyl (meth)acrylates and 2-(meth)acrylamide-2-methyl propane sulfonic acids, as well as salts thereof.

As for the amphoteric PAM, the components (a) to (c) may be further combined with (d) a cross-linking monomer and/or (e) a chain transfer agent to add a branched cross-linked structure to the copolymer ((d) accounts for approx. 0.02 to 0.5 percent by weight relative to the copolymer, while (e) accounts for approx. 0.1 to 1.5 percent by weight relative to the copolymer). The cross-linking monomer (d), which contributes to increasing the molecular weight of the copolymer and also increasing the interaction with the polysaccharide or pulp, may be a methylene bis-acrylamide (abbreviated as “MBAM”), ethylene bis(meth)acrylamide or other bis(meth)acrylamides, ethylene glycol di(meth)acrylate, diethylene glycol di(meth)acrylate or other di(meth)acrylates, dimethyl acrylamide (abbreviated as “DMAM”), or methacrylonitrile. The chain transfer agent (e), which has the effects of suppressing an increase in the viscosity of the copolymer and increasing the branched structure to adjust the molecular weight, may be an isopropyl alcohol (abbreviated as “IPA”), sodium metallyl sulfonic acid (abbreviated as “SMS”), sodium aryl sulfonic acid (abbreviated as “SAS”), n-dodecyl mercaptan, mercaptoethanol, thioglycollic acid or other mercaptan, or any other known chain transfer agent.

In addition, other monomers including nonionic monomers such as acrylonitrile may also be used in the amphoteric PAM, if necessary.

The components (a) to (c) of the amphoteric PAM may be used alone or in combination. The contents of the components (a) to (c) of the amphoteric PAM are arbitrary and not limited in any way. However, preferably the content of the (meth)acrylamide (a) should be in a range of 65 to 98.8 percent by mol, the content of the cationic monomer (b) should be in a range of 1 to 20 percent by mol, and the content of the anionic monomer (c) should be in a range of 0.2 to 15 percent by mol, relative to the copolymer.

On the other hand, the cationic acrylamide copolymer (referred to as “cationic PAM” as a matter of convenience) in the component (B) may comprise (a) a (meth)acrylamide and (b) a cationic monomer (the average molecular weight of the copolymer may be in a range of 200,000 to 4 million, for example).

As for these (meth)acrylamide (a) and cationic monomer (b), any of the substances cited as component monomers of the amphoteric PAM can be used in the same manner.

Also with this cationic PAM, the components (a) and (b) may be further combined with the cross-linking monomer (d) and/or chain transfer agent (e) to add a branched cross-linked structure to the copolymer. In addition, other monomers including nonionic monomers such as acrylonitrile may also be used in this cationic PAM, if necessary.

Furthermore, the components (a) and (b) of the cationic PAM can be used alone or in combination, just like with the amphoteric PAM.

The contents of the components (a) and (b) of the cationic PAM are arbitrary and not limited in any way. However, preferably the content of the (meth)acrylamide (a) should be in a range of 85 to 99 percent by mol, while the content of the cationic monomer (b) should be in a range of 1 to 15 percent by mol, relative to the copolymer.

The composite PAM is manufactured through a preparation method involving mixing of the components (A) and (B) (by dissolving them in water, for example), or polymerization of the component monomers of the component (B) in the presence of the component (A).

The combinations of components shown in (1) to (3) below can be used in the aforementioned mixing method:

(1) Anionic polysaccharide and amphoteric PAM
(2) Anionic polysaccharide and cationic PAM
(3) Anionic polysaccharide and amphoteric PAM and cationic PAM

By mixing the components (A) and (B), a polyion complex having both the anionic spreading structure of high molecular weight unique to a polysaccharide, as well as the cationic and hydecreasehilic characteristics unique to an acrylamide copolymer, can be formed.

On the other hand, the composite PAM can also be manufactured by allowing the component (A) to be present during the manufacture of the component (B) by means of a copolymerization reaction of component monomers.

To be specific, while acrylamides (a), cationic monomers (b) and anionic monomers (c) are used as the component monomers in the manufacture of an amphoteric or cationic PAM as explained above, these component monomers can be copolymerized in the presence of an anionic polysaccharide to allow the anionic polysaccharide to mix into the produced amphoteric or cationic PAM, and consequently these two components form a polyion complex.

In other words, with respect to the composite PAM under the present invention it is possible to add an anionic polysaccharide (A) before or after copolymerization reaction when manufacturing a cationic or amphoteric PAM through a copolymerization reaction, as long as a polyion complex is formed by the components (A) and (B).

When manufacturing the composite PAM under the present invention, the mixing ratio (ratio by weight) of the component (A) and component (B) should preferably be in a range of A/B=2/98 to 45/55, or more preferably in a range of 4/96 to 30/70, or yet more preferably in a range of 10/90 to 20/80.

If the anionic polysaccharide (A) is contained by more than 45 percent by weight, anions become excessive and the ratio of adsorption to the filler decreases. As a result, the particle size of the coated filler may not increase properly and the retention may also decrease. On the other hand, since one characteristic of the present invention is to combine two types of components having different charge characteristics, if the anionic polysaccharide (A) is contained by less than 2 percent by weight the intended effects of this composition will decrease.

Manufacturing Method

As for the amount of a processing agent, adjusting its content to a range of, for example, 0.1 to 3.0 percent by solid weight relative to the filler to be coagulated will make it easy to adjust the size of coagulated filler particles to a range of 10 to 80 μm, while making the coagulated filler less likely to break and more likely to maintain its shape in the papermaking machine. If the amount of processing agent is less than 0.1 percent by solid weight, the average size of coagulated filler particles tends to become smaller than 10 μm, and consequently a sufficient effect of improving paper strength cannot be achieved easily. On the other hand, adding a processing agent by more than 3.0 percent by solid weight does not achieve any greater effect of improving paper strength. On the contrary, the cost of the chemical used will increase, which is not desired in a practical application.

A pre-coagulated filler can be produced by mixing a processing agent with a filler in a water dispersion matrix. To be specific, a desired method of manufacturing a pre-coagulated filler is to add to a filler slurry a solution of a composite PAM prepared in advance from the component (A) and component (B). However, two solutions representing the component (A) and component (B) can be added to a filler slurry separately.

(Paper Added with Pre-Coagulated Filler)

The aforementioned pre-coagulated filler is added to a pulp material. In the papermaking process, it is desirable that this pre-coagulated filler be added after the mixer where various pulps are mixed, but before the head box. It is best that the pre-coagulated filler be added in the head box.

Adding Ratio

The ratio of the pre-coagulated filler in a paper conforming to the present invention is in a range of 3 to 40 percent by solid weight. A preferred range is 5 to 30 percent by solid weight, and a more preferred range is 7 to 25 percent by solid weight. If the ratio is less than 3 percent by solid weight, even though a favorable filler retention can be obtained and tearing of paper, delamination or generation of paper dust will not occur on offset rotary presses, nor paper jam or generation of paper dust will occur on copiers adopting the electronic photography method or laser beam printers, problems tend to occur easily such as insufficient opacity leading to significant strike-through and lower smoothness resulting in less than optimal print surface. If the ratio exceeds 40 percent by solid weight, on the other hand, a small pulp fiber content reduces the filler retention and other problems also tend to occur due to generation of a large amount of paper dust. The ash content in paper should preferably be in a range of 3 to 40 percent by solid weight. The ash content in paper comes from the added filler as well as other substances brought into the paper such as DIP and other pulp materials. Under the present invention, any filler without the aforementioned processing may be added as long as it does not reduce the intended effects of the present invention. Examples of such filler include calcium carbonate, kaolin, clay, hydrated silicic acid, white carbon, titanium oxide, precipitated calcium carbonate-silica complex compound, vinyl chloride resin, polystyrene resin and urea-formaldehyde resin, among others. Under the present invention, preferably 50 percent or more, or more preferably 70% or more, of the ash content in paper should be based on the pre-coagulated filler.

Especially with a clear coated printing paper, the ratio of this pre-coagulated filler is in a range of 5 to 40 percent by solid weight, for example. A preferred range is 7 to 35 percent by solid weight, and a more preferred range is 10 to 30 percent by solid weight. If the ratio is less than 5 percent by solid weight, even though a favorable filler retention can be obtained and delamination or generation of paper dust will not occur on offset presses, problems tend to occur easily such as insufficient opacity leading to significant strike-through and lower smoothness resulting in less than optimal print surface. If the ratio exceeds 40 percent by solid weight, on the other hand, problems tend to occur due to generation of a large amount of paper dust.

Papermaking Method

As for the papermaking machine used to make a paper conforming to the present invention, a gap former, hybrid former or on-top former having a mechanism for dewatering both sides of paper is desirable in order to suppress two-sidedness of paper. However, papermaking machines that can be used under the present invention are not at all limited to the aforementioned types. Pressing and calendering can be applied under any conditions within the ranges used in normal operations.

Surface Treatment Agent

Under the present invention, a paper added with the aforementioned pre-coagulated filler may be used as a base paper, and a surface treatment agent may be coated over the base paper. When manufacturing a neutral newsprint paper for offset printing, clear coated printing paper or electronic photograph transfer paper, coating a surface treatment agent can increase the surface strength. Also with a coated paper for printing, a surface treatment agent can be coated over a base paper before a coating layer is provided, in order to suppress permeation of the coating layer into the base paper.

Chemical agents that can be coated as a surface treatment agent include raw starch, oxidized starch, esterified starch, cationized starch, heat denatured starch, enzyme denatured starch, aldehydized starch, hydroxyethylated starch and other denatured starches; carboxymethyl cellulose, hydroxyethyl cellulose, methyl cellulose and other cellulose derivatives; polyvinyl alcohol, carboxyl denatured polyvinyl alcohol and other denatured alcohols; styrene butadiene copolymer, polyvinyl acetate, vinyl chloride-vinyl acetate copolymer, polyvinyl chloride, polyvinylidene chloride, ester polyacrylate, and acrylamide, which can be used alone or in combination (these chemical agents are hereinafter collectively referred to as “surface paper strength agents”). Among the above, the most preferred substance to be coated is hydroxyethylated starch that offers an excellent effect of improving surface strength. The coating weight (solid content) of a surface paper strength agent is approx. 0.05 to 2 g/m².

In addition to the aforementioned chemical agents that are coated as a surface treatment agent, other chemical agents such as styrene acrylate, styrene maleiate, olefin compounds and other general surface sizing agents can be coated together. Among others, the inventors found that use of a cationic surface sizing agent would achieve very favorable surface strength. With neutral papermaking matrixes where calcium carbonate is used as a filler, a smaller amount of aluminum sulfate exhibiting cationic property is used. Accordingly, a cationic surface sizing agent remains near the paper surface more effectively and thereby improves the sizing property of paper. Since this improved sizing property reduces permeation of water into the paper during offset printing, surface strength can be maintained at higher levels.

Examples of such cationic surface sizing agent include the following, among others: a water-soluble copolymer whose primary component is a styrene monomer (International Patent Laid-open No. WO2005/003457); a copolymer produced by means of polymerization in the presence of a chain transfer agent using a lipophilic organic solvent (Japanese Patent Laid-open No. 2005-248338); a copolymer whose primary component is an alkyl (meth)acrylate having an alkyl group of C1 to C4, produced by means of solution polymerization in an organic solvent in the presence of a chain transfer agent (Japanese Patent Laid-open No. 2006-161259); and a copolymer whose primary component is an alkyl (meth)acrylate having an alkyl group of C6 to C18, produced by means of solution polymerization in an organic solvent of high boiling point in the presence of a chain transfer agent (Japanese Patent Laid-open No. 2006-322093). However, cationic surface sizing agents that can be used under the present invention are not at all limited to the foregoing. The coating weight (solid content) of a surface sizing agent is in a range of approx. 0.01 to 0.2 g/m². If a surface treatment agent containing both a surface paper strength agent and a surface sizing agent is coated over a base paper, the mixing ratio of such surface paper strength agent and surface sizing agent should be adjusted within a known range and is not limited in any way. However, an appropriate ratio is 100 parts of a surface paper strength agent to 1 to 30 parts of a surface sizing agent, where the ratio of a surfaced sizing agent should be preferably be adjusted to a range of 1 to 20 parts, or more preferably to a range of 1 to 15 parts.

In the case of an electronic photograph transfer paper, an inorganic conductive agent such as sodium chloride, sodium sulfate or potassium chloride, or organic conductive agent such as dimethyl aminoethyl methacrylate, can be coated to control the electrical resistivity. In this case, the coating agent to be used and its coating weight can be adjusted as deemed necessary. Normally the coating weight (solid content) of such agent is in a range of approx. 0.5 to 4 g/m².

An apparatus used to coat a surface treatment agent over a base paper under the present invention may be a blade coater, gate-roll coater, sizing press coater or any other coater in the public domain, and is not limited in any way. A preferred method is to use a gate-roll coater as a newsprint papermaking machine, or use a sym sizer or gate-roll sizing press or other film-transfer type machine when making a clear coated printing paper or electronic photograph transfer paper.

Additive Chemicals

For a paper conforming to the present invention, alkyl ketene dimer sizing agent, alkenyl succinic anhydride sizing agent, neutral rosin sizing agent or other neutral sizing agent, acrylamide, cationic starch or other dry paper strength agent, polyamide amine epichlorohydrin or other wet paper strength agent may be used as an additive chemical, in addition to the pulp and filler. Also, any known inorganic coagulant (aluminum sulfate, etc.) or organic polymer coagulant may be added to improve the filler retention further, and also any known retention enhancing system (such as the Hydrocol system, Composil system, etc.) can be used in combination.

There have been efforts to increase the paper bulk by adding paper-bulk increasing agents in recent years. However, most of these bulk increasing agents have the negative effect of reducing paper strength and stiffness, and applying the present invention to a paper that contains such bulk increasing agents and consequently has lower paper strength or stiffness will achieve a greater effect of adding paper to strength and stiffness and consequently suppress paper jam or generation of paper dust despite the increased bulk of paper.

A paper conforming to the present invention can contain a paper-bulk increasing agent in addition to the additive chemicals mentioned above. Specific examples of compounds that can be used as the paper-bulk increasing agent include oil-based nonionic surface active agents, sugar-alcohol nonionic surface active agents, sugar nonionic surface active agents, polyalcohol nonionic surface active agents, esterified compounds of polyalcohol and fatty acid, polyoxyalkylene adducts of higher alcohol or higher fatty acid, polyoxyalkylene adducts of higher fatty acid ester, polyoxyalkylene adducts of esterified compound of polyalcohol and fatty acid, fatty acid polyamide amines, straight-chain fatty acid monoamides, unsaturated fatty acid monoamides, and unsaturated fatty acid diamide amines, among others.

Examples of these paper-bulk increasing agents can be found in patent literatures, as follows: a paper-bulk increasing agent described in Japanese Patent No. 3128248; a paper-bulk increasing agent described in Japanese Patent No. 3453505; a paper-bulk increasing agent described in Japanese Patent No. 3482336; a paper-bulk increasing agent described in Japanese Patent No. 3537692; a paper-bulk increasing agent described in Japanese Patent No. 3482337; a paper-bulk increasing agent described in Japanese Patent No. 2971447; a paper-quality improving agent for papermaking described in Japanese Patent No. 3283248; a dry efficiency improving agent described in Japanese Patent No. 3387033; a smoothness and air-permeability improving agent described in Japanese Patent No. 3387036; an additive for papermaking described in Japanese Patent No. 3517200; a paper-quality improving agent for papermaking described in Japanese Patent Laid-open No. 2001-248100; a paper-quality improving agent described in Japanese Patent Laid-open No. 2003-336196; a paper opacifying agent described in Japanese Patent Laid-open No. 2000-273792; an additive for paper recycling described in Japanese Patent Laid-open No. 2002-129497; an additive for paper recycling described in Japanese Patent Laid-open No. 2002-275786; an additive for paper recycling described in Japanese Patent Laid-open No. 2002-294586; a bulk increasing agent described in Japanese Patent Laid-open No. 2002-294594; a paper-bulk increasing agent described in Japanese Patent Laid-open No. 2003-96692; a bulk increasing agent described in Japanese Patent Laid-open No. 2003-96693; an additive for paper recycling described in Japanese Patent Laid-open No. 2003-96694; an additive for paper recycling described in Japanese Patent Laid-open No. 2003-96695; a paper-thickness improving agent described in Japanese Patent Laid-open No. 2003-171897; a paper-bulk increasing agent described in Japanese Patent Laid-open No. 2003-247197; a paper-bulk increasing agent described in Japanese Patent Laid-open No. 2003-253588; a paper-bulk increasing agent described in Japanese Patent Laid-open No. 2003-253589; a paper-bulk increasing agent described in Japanese Patent Laid-open No. 2003-253590; a paper-density reducing agent described in Japanese Patent Laid-open No. 2003-328297; a paper-density reducing agent described in Japanese Patent Laid-open No. 2003-313799; an additive for papermaking described in Japanese Patent Laid-open No. 2004-11058; a paper-density reducing agent described in Japanese Patent Laid-open No. 2004-27401; a paper-density reducing agent described in Japanese Patent Laid-open No. 2004-115935; a paper-bulk increasing agent described in Japanese Patent Laid-open No. 2004-76244; a paper reforming agent described in Japanese Patent Laid-open No. 2004-176213; a paper softening agent described in Japanese Patent No. 3521422; a bulk increasing and softening agent described in Japanese Patent Laid-open No. 2002-275792; a bulk increasing and sizing agent for papermaking described in Japanese Patent Laid-open No. 2002-275792; a paper-bulk increasing agent described in Japanese Patent Laid-open No. 2003-286692; a composition for bulk increasing agent for papermaking described in Japanese Patent Laid-open No. 2004-270074; a bulk increasing agent for papermaking described in Japanese Patent Laid-open No. 2004-285490; a paper-bulk increasing agent described in Japanese Patent Laid-open No. 2004-339629; a bulk increasing agent described in Japanese Patent Laid-open No. 2005-54330; and a bulk increasing agent described in Japanese Patent Laid-open No. 2005-68592.

Normally, a bulk increasing agent is added by a range of 0.2 to 20 percent by solid weight relative to the material pulp. If a bulk increasing agent is added by less than 0.2 percent by solid weight, the density reducing effect becomes smaller. On the other hand, adding a bulk increasing agent more than 20 percent by solid weight does not increase the bulk increasing effect further and thus makes no sense in terms of cost or practicality. A preferred point at which to add a bulk increasing agent is after the material mixer, but before adding a mixed slurry comprising inorganic particles and any of the aforementioned processing agents used under the present invention or any other filler.

Coating Layer

When manufacturing a coated paper for printing, normally a coating layer primarily comprising pigment and adhesive is provided over a base paper obtained in accordance with the aforementioned method. Pigments that have been traditionally used as paper coating pigments can be used in the coating layer. Clay, kaolin, ground calcium carbonate, precipitated calcium carbonate, talc, titanium dioxide, barium sulfate, calcium sulfate, zinc oxide, silicic acid, silicate, colloidal silica, satin white and other inorganic pigments, or plastic pigments and other organic pigments, are some of the types of pigments that can be used. These pigments may be used alone or two or more of them may be combined.

Adhesives that can be used under the present invention include adhesives traditionally used in coating papers, including the following: various copolymers such as styrene-butadiene copolymer, styrene-acrylic copolymer, ethylene-vinyl acetate copolymer, butadiene-methyl methacrylate copolymer and vinyl acetate-butyl acrylate copolymer; synthetic adhesives based on polyvinyl alcohol, maleic anhydride copolymer and acrylate-methyl methacrylate copolymer; proteins such as casein, soy protein and synthetic protein; starches such as oxidized starch, cationized starch, urea phosphoric acid esterified starch and hydroxyethyl etherified starch; and cellulose derivatives such as carboxymethyl cellulose, hydroxymethyl cellulose and hydroxyethyl cellulose. One or more of the foregoing substances may be selected and used as deemed appropriate. These adhesives should preferably be used in a range of 5 to 35 parts by weight relative to 100 parts by weight of the pigment. If the adhesive content exceeds 35 parts by weight, the viscosity of coating material becomes higher and undesirable effects may occur such as the material not passing the piping or screen easily or presenting other operational problems. If the adhesive content is less than 5 parts by weight, on the other hand, sufficient surface strength cannot be achieved, which is undesirable.

Coating solutions that can be used under the present invention may contain various auxiliaries normally used, such as dispersants, thickening agents, water retaining agents, defoaming agents, waterproofing agents, dyes and fluorescent dyes, among others.

The method to coat an adjusted coating solution over a base paper under the present invention is not limited in any way, and any known coating apparatus may be used. For example, a blade coater, bar coater, roll coater, air-knife coater, reverse-roll coater, curtain coater, sizing press coater or gate-roll coater can be used, among others. Any of these coaters can be used to coat one, two or more layers on one side or both sides of the base paper. The coating weight per side should preferably be in a range of 3 to 25 g/m², or more preferably in a range of 5 to 15 g/m². If the coating weight per side is less than 3 g/m², the base paper cannot be coated sufficiently and poor ink impression will result.

Normal methods can be used to dry a wet coated layer, such as using a steam heater, gas heater, infrared heater, electric heater, hot-air heater, or microwave or cylinder drier.

If necessary, a coated paper for printing conforming to the present invention can undergo a finish process after drying, such as super-calendering, high-temperature soft calendaring or other post-processing, so as to add smoothness.

Various Properties of Each Paper

The various properties of a paper obtained under the present invention can be designed as deemed appropriate according to the purpose of the paper. In the case of a neutral newsprint paper for offset printing, however, the basis weight should desirably be in a range of, for example, 37 to 52 g/m². In the case of a clear coated printing paper, the density should desirably be in a range of, for example, 0.3 to 0.9 g/cm³. In the case of an electronic photograph transfer paper, the basis weight should desirably be in a range of, for example, 40 to 80 g/m², because a paper in this basis weight range can also be used as an inkjet recording paper. In the case of a coated paper for printing, the density should preferably be in a range of, for example, 0.4 to 1.3 g/cm³. The smoothness, friction coefficient and other properties of each of these papers only need to be in normal ranges.

For your information, the phrase “present invention” used in this Specification refers to an “embodiment of the present invention” and references to this phrase are not intended to limit the present invention itself. Also, conditions and elements not described in this Specification are those that can be normally implemented by those skilled in the art with ease.

### EXAMPLES

Although the present invention applies to papers in general, examples and comparative examples involving newsprint papers for offset printing, clear coated printing papers, electronic photograph transfer papers and coated papers for printing are used as representative examples to explain the present invention in details below. It goes without saying, however, that the present invention is not at all limited to these examples. Parts and percentages used in the examples and comparative examples indicate weight parts or percentages by weight, unless otherwise indicated.

### (1) Preparation Method for Pre-Coagulated Filler

Each pre-coagulated filler was obtained by mixing a processing agent with a filler in water using a static mixer. The average particle sizes of fillers and pre-coagulated fillers were measured with Mastersizer 2000 manufactured by Malvern Instruments. The laser diffraction method was used as the measurement principle.

Explained below are examples of synthesizing amphoteric and cationic acrylamide copolymers (PAM-1 and PAM-2) and anionic acrylamide copolymer (PAM-3) to be used as materials of composite PAMs conforming to the present invention.

### [PAM-1] (Example of Synthesis 1)

A mixture comprising 670 parts of water, 262 parts of 50% aqueous acrylamide solution, 18.6 parts of 60% methacryloyloxyethyl dimethyl benzyl ammonium chloride, 9.2 parts of dimethyl aminopropyl acrylamide, 3.9 parts of itaconic acid, 0.1 part of methylene bis-acrylamide and 0.5 part of sodium allyl sulfonic acid, was adjusted to pH 3 using 10% sulfuric acid.

Next, the mixture was heated to 60° C. and then further mixed with 16 parts of 2% aqueous ammonium persulfate solution and 4 parts of 2% aqueous sodium sulfite solution to cause reaction for 3 hours at a temperature of 60 to 85° C. to obtain PAM-1.

### [PAM-2] (Example of Synthesis 2)

A mixture comprising 670 parts of water, 262 parts of 50% aqueous acrylamide solution, 40.5 parts of 60% methacryloyloxyethyl dimethyl benzyl ammonium chloride, 18.9 parts of dimethyl aminoethyl methacrylate, 6.2 parts of 98% acrylic acid and 0.5 part of sodium methallyl sulfonic acid, was adjusted to pH 3 using 10% sulfuric acid.

Next, the mixture was heated to 60° C. and then further mixed with 16 parts of 2% aqueous ammonium persulfate solution and 4 parts of 2% aqueous sodium sulfite solution to cause reaction for 3 hours at a temperature of 60 to 85° C. to obtain PAM-2.

### [PAM-3] (Example of Synthesis 3)

A mixture comprising 670 parts of water, 262 parts of 50% aqueous acrylamide solution, 33.2 parts of 98% acrylic acid and 0.5 part of sodium allyl sulfonic acid, was adjusted to pH 3 using 10% sulfuric acid.

Next, the mixture was heated to 60° C. and then further mixed with 16 parts of 2% aqueous ammonium persulfate solution and 4 parts of 2% aqueous sodium sulfite solution to cause reaction for 3 hours at a temperature of 60 to 85° C. to obtain PAM-3.

Next, an example of manufacturing composite PAM-C1 by mixing PAM-1 (amphoteric PAM) obtained in example of synthesis 1 above with an anionic polysaccharide (CMC) is explained. Also, an example of manufacturing PAM-C2 by mixing PAM-2 (cationic PAM) and PAM-3 (anionic PAM) obtained in examples of synthesis 2 and 3 above, without using any anionic polysaccharide, is explained.

### [Composite PAM1 (PAM-C1)]

A CMC (anionic polysaccharide: component A) and an amphoteric PAM-1 (component B) were made into 1% solutions, respectively, and both solutions were mixed in a water matrix at a weight ratio of A/B=15/85 to obtain PAM-C1 (composite PAM1).

### [Composite PAM2 (PAM-C2)]

A cationic PAM (PAM-2: component B) and an anionic PAM (PAM-3: non-B component) were mixed in a water matrix at a weight ratio of PAM-2/PAM-3=85/15, without using any anionic polysaccharide (CMC), to obtain PAM-C2 (composite PAM2). (For your information, the term “composite” refers to composition of the component A (anionic polysaccharide) and component B (amphoteric/cationic PAM), and therefore strictly speaking PAM-C2 using no anionic polysaccharide is not a composite PAM. However, it is referred to as a “composite PAM” as a matter of convenience for statement in the tables shown later).

Next, the method of preparing each pre-coagulated filler by mixing a composite PAM with a filler is explained.

### [Pre-Coagulated Filler 1]

Using ground calcium carbonate (average particle size: 1.5 μm) as a filler and composite PAM-C1 as a processing agent, pre-coagulation was carried out at a mixing ratio of ground calcium carbonate/PAM-C1=100/0.7 to obtain a pre-coagulated filler with an average particle size of 27 μm.

### [Pre-Coagulated Filler 2]

Using precipitated calcium carbonate (Rosetta type; average particle size: 3 μm) as a filler and composite PAM-C1 as a processing agent, pre-coagulation was carried out at a mixing ratio of ground calcium carbonate/PAM-C1=100/0.7 to obtain a pre-coagulated filler with an average particle size of 38 μm.

### [Pre-Coagulated Filler 3]

Using precipitated calcium carbonate (Rosetta type; average particle size: 3 μm) as a filler and composite PAM-C1 as a processing agent, pre-coagulation was carried out at a mixing ratio of precipitated calcium carbonate/PAM-C1=100/0.2 to obtain a pre-coagulated filler with an average particle size of 14 μm.

### [Pre-Coagulated Filler 4]

Using precipitated calcium carbonate (Rosetta type; average particle size: 3 μm) as a filler and composite PAM-C1 as a processing agent, pre-coagulation was carried out at a mixing ratio of precipitated calcium carbonate/PAM-C1=100/2.5 to obtain a pre-coagulated filler with an average particle size of 41 μm.

### [Pre-Coagulated Filler 5]

Using precipitated calcium carbonate (Rosetta type; average particle size: 3 μm) as a filler and composite PAM-C1 as a processing agent, pre-coagulation was carried out at a mixing ratio of precipitated calcium carbonate/PAM-C1=100/0.05 to obtain a pre-coagulated filler with an average particle size of 8 μm.

### [Pre-Coagulated Filler 6]

Using precipitated calcium carbonate (Rosetta type; average particle size: 3 μm) as a filler and composite PAM-C2 as a processing agent, pre-coagulation was carried out at a mixing ratio of precipitated calcium carbonate/PAM-C2=100/0.7 to obtain a pre-coagulated filler with an average particle size of 8 μm.

### [Pre-Coagulated Filler 7]

Using precipitated calcium carbonate (Rosetta type; average particle size: 3 μm) as a filler and CMC as a processing agent, pre-coagulation was carried out at a mixing ratio of precipitated calcium carbonate/CMC=100/0.7 to obtain a pre-coagulated filler with an average particle size of 5 μm.

Newsprint Paper for Offset Printing

A pre-coagulated filler was added to a material pulp slurry (DIP/TMP/NKP=70/15/15; cation demand: 77 μeq/l) by the amount shown in each of the following examples and comparative examples to make a base newsprint paper with a basis weight of 40.5 g/m² under a neutral papermaking method using a gap-former papermaking machine operated at a speed of 1,600 m/min, after which a surface treatment agent (surface paper strength agent and/or surface sizing agent) was coated on both sides of the base paper to 0.6 g/m² using an on-machine gate-roll coater to obtain a neutral newsprint paper for offset printing (Examples 1 to 7 and Comparative Examples 1 to 6). The obtained neutral newsprint paper for offset printing was evaluated for tearing, paper dust and ink impression using a printing test conducted on an offer rotary press.

### (1) Evaluation Methods for Tearing, Paper Dust and Ink Impression

An offset rotary press by Toshiba was used to print 60,000 copies in single black color at a printing speed of 900 rpm to count the number of copies torn. As for paper dust, the paper dust attached to the blanket cylinder after printing of 60,000 copies was scraped off and the weight of obtained paper dust was measured and indicated per 100 cm². Also, ink impression was visually evaluated (⊚: Excellent, ◯: Good, Δ: Slightly poor, x: Poor). The film thickness of damping water was adjusted to 0.9 μm. The evaluation results are shown in Table 1.

### (2) Measurement Method for Ash Content in Paper (Percent by Weight)

Measurement was conducted according to JIS P 8251 (corresponding to ISO 1762), where ashing was carried out for 2 hours at 525° C. (The same method was used in all examples and comparative examples explained below.)

### Example 1

Pre-coagulated filler 2 described above was added to a material pulp slurry in the head box to make a paper stuff, and then hydroxyethylated starch was coated as a surface treatment agent to obtain a neutral newsprint paper for offset printing having a filler content in paper of 15%.

### Example 2

Pre-coagulated filler 2 described above was added to a material pulp slurry in the head box to make a paper stuff, and then hydroxyethylated starch was coated as a surface treatment agent to obtain a neutral newsprint paper for offset printing having a filler content in paper of 30%.

### Example 3

Pre-coagulated filler 1 described above was added to a material pulp slurry in the head box to make a paper stuff, and then hydroxyethylated starch was coated as a surface treatment agent to obtain a neutral newsprint paper for offset printing having a filler content in paper of 15%.

### Example 4

Pre-coagulated filler 4 described above was added to a material pulp slurry in the head box to make a paper stuff, and then hydroxyethylated starch was coated as a surface treatment agent to obtain a neutral newsprint paper for offset printing having a filler content in paper of 15%.

### Example 5

Pre-coagulated filler 3 described above was added to a material pulp slurry in the head box to make a paper stuff, and then hydroxyethylated starch was coated as a surface treatment agent to obtain a neutral newsprint paper for offset printing having a filler content in paper of 15%.

### Example 6

Pre-coagulated filler 2 described above was added to a material pulp slurry in the head box to make a paper stuff, and then oxidized starch was coated as a surface treatment agent to obtain a neutral newsprint paper for offset printing having a filler content in paper of 15%.

### Example 1-1

A neutral newsprint paper for offset printing was obtained in the same manner as explained in Example 1, except that a coating solution to which a cationic surface sizing agent (copolymer comprising 100 parts of acrylic ester and 25 parts of quaternized (salt of) dimethyl aminoethyl methacrylate) was added by 20 percent by solid weight relative to hydroxyethylated starch was coated as a surface treatment agent.

### Comparative Example 1

The precipitated calcium carbonate and composite PAM constituting pre-coagulated filler 2 described above were added separately to a material pulp slurry in the head box to make a paper stuff, and then hydroxyethylated starch was coated as a surface treatment agent to obtain a neutral newsprint paper for offset printing having a filler content in paper of 15%. The ratio of precipitated calcium carbonate and composite PAM was the same as the ratio used to prepare pre-coagulated filler 2.

### Comparative Example 2

Pre-coagulated filler 2 described above was added to a material pulp slurry in the head box to make a paper stuff, and then hydroxyethylated starch was coated as a surface treatment agent to obtain a neutral newsprint paper for offset printing having a filler content in paper of 2%.

### Comparative Example 3

Pre-coagulated filler 2 described above was added to a material pulp slurry in the head box to make a paper stuff, and then hydroxyethylated starch was coated as a surface treatment agent to obtain a neutral newsprint paper for offset printing having a filler content in paper of 50%.

### Comparative Example 4

Pre-coagulated filler 5 described above was added to a material pulp slurry in the head box to make a paper stuff, and then hydroxyethylated starch was coated as a surface treatment agent to obtain a newsprint paper for offset printing having a filler content in paper of 15%.

### Comparative Example 5

Pre-coagulated filler 6 described above was added to a material pulp slurry in the head box to make a paper stuff, and then hydroxyethylated starch was coated as a surface treatment agent to obtain a newsprint paper for offset printing having a filler content in paper of 15%.

### Comparative Example 6

Pre-coagulated filler 7 described above was added to a material pulp slurry in the head box to make a paper stuff, and then hydroxyethylated starch was coated as a surface treatment agent to obtain a newsprint paper for offset printing having a filler content in paper of 15%.

TABLE 1

| | | Pre-coagulated filler | | | | | |
|---|---|---|---|---|---|---|---|
| | | | | | Processing agent | | |
| | | | | | | Ratio of | Solid weight ratio |
| | Material | Type | Particle | | Composite | (A)/(B) in | Filler/processing |
| | pulp | No. | size μm | Filler | PAM | composite PAM | agent |
| Example 1 | DIP/TMP/NKP = | 2 | 38 | Precipitated | PAM-C1 | 15/85 | 100/0.7 |
| | 70/15/15 | | | calcium carbonate | | | |
| Example 2 | Cation demand | 2 | 38 | Precipitated | PAM-C1 | 15/85 | 100/0.7 |
| | 77 μeq/l | | | calcium carbonate | | | |
| Example 3 | | 1 | 27 | Ground | PAM-C1 | 15/85 | 100/0.7 |
| | | | | calcium carbonate | | | |
| Example 4 | | 4 | 41 | Precipitated | PAM-C1 | 15/85 | 100/2.5 |
| | | | | calcium carbonate | | | |
| Example 5 | | 3 | 14 | Precipitated | PAM-C1 | 15/85 | 100/0.2 |
| | | | | calcium carbonate | | | |
| Example 6 | | 2 | 38 | Precipitated | PAM-C1 | 15/85 | 100/0.7 |
| | | | | calcium carbonate | | | |
| Example 1-1 | | 2 | 38 | Precipitated | PAM-C1 | 15/85 | 100/0.7 |
| | | | | calcium carbonate | | | |
| Comparative | | — | — | Precipitated calcium carbonate | | 15/85 | 100/0.7 |
| Example 1 | | | | and PAM-C1 added separately | | | |
| Comparative | | 2 | 38 | Precipitated | PAM-C1 | 15/85 | 100/0.7 |
| Example 2 | | | | calcium carbonate | | | |
| Comparative | | 2 | 38 | Precipitated | PAM-C1 | 15/85 | 100/0.7 |
| Example 3 | | | | calcium carbonate | | | |
| Comparative | | 5 | 8 | Precipitated | PAM-C1 | 15/85 | 100/0.05 |
| Example 4 | | | | calcium carbonate | | | |
| Comparative | | 6 | 8 | Precipitated | PAM-C2 | 0/100 | 100/0.7 |
| Example 5 | | | | calcium carbonate | | | |
| Comparative | | 7 | 5 | Precipitated | CMC | 100/0 | 100/0.7 |
| Example 6 | | | | calcium carbonate | | | |

| | | Printing results using offset press | | | |
|---|---|---|---|---|---|
| | | Number of | Amount of | | |
| | Surface | torn copies | paper dust | Evaluation of | Ash content in |
| | treatment agent | Copies per 60,000 | mg/100 cm² | ink impression | base paper % |
| Example 1 | Hydroxyethylated | 0 | 7 | ◯ | 15 |
| | starch | | | | |
| Example 2 | Hydroxyethylated | 0 | 11 | ⊚ | 30 |
| | starch | | | | |
| Example 3 | Hydroxyethylated | 0 | 5 | ◯ | 15 |
| | starch | | | | |
| Example 4 | Hydroxyethylated | 0 | 13 | ⊚ | 15 |
| | starch | | | | |
| Example 5 | Hydroxyethylated | 0 | 16 | ◯ | 15 |
| | starch | | | | |
| Example 6 | Oxidized | 0 | 26 | ◯ | 15 |
| | starch | | | | |
| Example 1-1 | Hydroxyethylated | 0 | 6 | ◯ | 15 |
| | starch | | | | |
| | Cationic surface | | | | |
| | sizing agent | | | | |
| Comparative | Hydroxyethylated | 2 | 82 | ◯ | 15 |
| Example 1 | starch | | | | |
| Comparative | Hydroxyethylated | 0 | 5 | X | 2 |
| Example 2 | starch | | | | |
| Comparative | Hydroxyethylated | 11 | 124 | ◯ | 50 |
| Example 3 | starch | | | | |
| Comparative | Hydroxyethylated | 4 | 79 | ◯ | 15 |
| Example 4 | starch | | | | |
| Comparative | Hydroxyethylated | 2 | 48 | ◯ | 15 |
| Example 5 | starch | | | | |
| Comparative | Hydroxyethylated | 1 | 39 | ◯ | 15 |
| Example 6 | starch | | | | |

As shown, all Examples conforming to the present invention produced good results in terms of the number of paper break, paper dust and evaluation of ink impression. Based on comparison of Example 1 and Comparative Example 1, it is clear that adding a pre-coagulated filler results in higher paper strength and less tearing or paper dust generation compared to when a filler and a processing agent are added separately. Based on comparison of Examples 1 and 2 and Comparative Examples 2 and 3, it is clear that with a neutral newsprint paper for offset printing, an ash content in paper of less than 3% results in poor ink impression, while an ash content in paper exceeding 40% increases the likelihood of tearing and also increases the amount of paper dust, leading to a conclusion that specifications with ash contents in these ranges are not practicable. In Comparative Example 4 where the pre-coagulated filler had a smaller particle size and the composite PAM was added by a smaller amount, tearing occurred and paper dust generated due to lower strength. From the results of Comparative Examples 5 and 6, it is clear that use of a composite PAM prepared from only the component (A) or only the component (B) provides less strength improving effect and poor offset printability.

### Clear Coated Printing Paper

A pre-coagulated filler was added to a material pulp slurry (NKP/LKP/TMP/GP/DIP=10/10/40/30/10; cation demand: 28 μeq/l) by the amount shown in each of the following examples and comparative examples to make a base clear coated printing paper with a basis weight of 60.0 g/m² using an on-top papermaking machine operated at a speed of 800 m/min, after which a surface treatment agent (surface paper strength agent and/or surface sizing agent) was coated on both sides of the base paper to 1.3 g/m² using an on-machine gate-roll coater to obtain a clear coated printing paper (Examples 7 to 12 and Comparative Examples 7 to 12). The obtained clear coated printing paper was measured for the number of delaminated copies and amount of paper dust and evaluated for perceived quality of print surface using a printing test conducted on an offer press.

### (1) Evaluation Methods for Delamination, Amount of Paper Dust and Perceived Quality of Print Surface

A sheet-fed offset press (Perfector 44 by Komori) was used to print 1,000 duodecimo-size copies in a monochrome, double-sided mode in landscape orientation at a speed of 8,500 copies per hour to count the number of delaminated copies. As for paper dust, the paper dust attached to the blanket cylinder after printing of 1,000 copies was scraped off and the weight of obtained paper dust was measured and indicated per 100 cm². Also, perceived quality of print surface was visually evaluated (⊚: Excellent, ◯: Good, Δ: Slightly poor, x: Poor). The evaluation results are shown in Table 2.

### Example 7

Pre-coagulated filler 2 described above was added to a material pulp slurry in the head box to make a paper stuff, and then heat denatured starch was coated as a surface treatment agent to obtain a clear coated printing paper having an ash content in paper of 15%.

### Example 8

Pre-coagulated filler 2 described above was added to a material pulp slurry in the head box to make a paper stuff, and then heat denatured starch was coated as a surface treatment agent to obtain a clear coated printing paper having an ash content in paper of 30%.

### Example 9

Pre-coagulated filler 1 described above was added to a material pulp slurry in the head box to make a paper stuff, and then heat denatured starch was coated as a surface treatment agent to obtain a clear coated printing paper having a filler content in paper of 15%.

### Example 10

Pre-coagulated filler 4 described above was added to a material pulp slurry in the head box to make a paper stuff, and then heat denatured starch was coated as a surface treatment agent to obtain a clear coated printing paper having an ash content in paper of 15%.

### Example 11

Pre-coagulated filler 3 described above was added to a material pulp slurry in the head box to make a paper stuff, and then heat denatured starch was coated as a surface treatment agent to obtain a clear coated printing paper having an ash content in paper of 15%.

### Example 12

Pre-coagulated filler 2 described above was added to a material pulp slurry in the head box to make a paper stuff, and then hydroxyethylated starch was coated as a surface treatment agent to obtain a clear coated printing paper having an ash content in paper of 15%.

### Comparative Example 7

The precipitated calcium carbonate and composite PAM constituting pre-coagulated filler 2 described above were added separately to a material pulp slurry in the head box to make a paper stuff, and then heat denatured starch was coated as a surface treatment agent to obtain a clear coated printing paper having an ash content in paper of 15%. The ratio of precipitated calcium carbonate and composite PAM was the same as the ratio used to prepare pre-coagulated filler 2.

### Comparative Example 8

Pre-coagulated filler 2 described above was added to a material pulp slurry in the head box to make a paper stuff, and then heat denatured starch was coated as a surface treatment agent to obtain a clear coated printing paper having an ash content in paper of 3%.

### Comparative Example 9

Pre-coagulated filler 2 described above was added to a material pulp slurry in the head box to make a paper stuff, and then heat denatured starch was coated as a surface treatment agent to obtain a clear coated printing paper having an ash content in paper of 50%.

### Comparative Example 10

Pre-coagulated filler 5 described above was added to a material pulp slurry in the head box to make a paper stuff, and then heat denatured starch was coated as a surface treatment agent to obtain a clear coated printing paper having an ash content in paper of 15%.

### Comparative Example 11

Pre-coagulated filler 6 described above was added to a material pulp slurry in the head box to make a paper stuff, and then heat denatured starch was coated as a surface treatment agent to obtain a clear coated printing paper having an ash content in paper of 15%.

### Comparative Example 12

Pre-coagulated filler 7 described above was added to a material pulp slurry in the head box to make a paper stuff, and then heat denatured starch was coated as a surface treatment agent to obtain a clear coated printing paper having an ash content in paper of 15%.

TABLE 2

| | | Pre-coagulated filler | | | | | |
|---|---|---|---|---|---|---|---|
| | | | | | Processing agent | | |
| | | | | | | Ratio of | Solid weight ratio |
| | Material | Type | Particle | | Composite | (A)/(B) in | Filler/processing |
| | pulp | No. | size μm | Filler | PAM | composite PAM | agent |
| Example 7 | NKP/LKP/TMP/ | 2 | 38 | Precipitated | PAM-C1 | 15/85 | 100/0.7 |
| | GP/DIP = | | | calcium carbonate | | | |
| Example 8 | 10/10/40/30/10 | 2 | 38 | Precipitated | PAM-C1 | 15/85 | 100/0.7 |
| | Cation demand: | | | calcium carbonate | | | |
| Example 9 | 28 μeq/l | 1 | 27 | Ground | PAM-C1 | 15/85 | 100/0.7 |
| | | | | calcium carbonate | | | |
| Example 10 | | 4 | 41 | Precipitated | PAM-C1 | 15/85 | 100/2.5 |
| | | | | calcium carbonate | | | |
| Example 11 | | 3 | 14 | Precipitated | PAM-C1 | 15/85 | 100/0.2 |
| | | | | calcium carbonate | | | |
| Example 12 | | 2 | 38 | Precipitated | PAM-C1 | 15/85 | 100/0.7 |
| | | | | calcium carbonate | | | |
| Comparative | | — | — | Precipitated calcium carbonate | | 15/85 | 100/0.7 |
| Example 7 | | | | and PAM-C1 added separately | | | |
| Comparative | | 2 | 38 | Precipitated | PAM-C1 | 15/85 | 100/0.7 |
| Example 8 | | | | calcium carbonate | | | |
| Comparative | | 2 | 38 | Precipitated | PAM-C1 | 15/85 | 100/0.7 |
| Example 9 | | | | calcium carbonate | | | |
| Comparative | | 5 | 8 | Precipitated | PAM-C1 | 15/85 | 100/0.7 |
| Example 10 | | | | calcium carbonate | | | |
| Comparative | | 6 | 8 | Precipitated | PAM-C2 | 0/100 | 100/0.05 |
| Example 11 | | | | calcium carbonate | | | |
| Comparative | | 7 | 5 | Precipitated | CMC | 100/0 | 100/0.7 |
| Example 12 | | | | calcium carbonate | | | |

| | | Printing results using sheet-fed offset press | | | |
|---|---|---|---|---|---|
| | | Number of | Amount of | Perceived | |
| | Surface | delaminated copies | paper dust | quality of | Ash content in |
| | treatment agent | Copies per 1,000 | mg/100 cm² | print surface | base paper % |
| Example 7 | Heat denatured | 0 | 13 | ◯ | 15 |
| | starch | | | | |
| Example 8 | Heat denatured | 0 | 25 | ⊚ | 30 |
| | starch | | | | |
| Example 9 | Heat denatured | 0 | 12 | ◯ | 15 |
| | starch | | | | |
| Example 10 | Heat denatured | 0 | 15 | ◯ | 15 |
| | starch | | | | |
| Example 11 | Heat denatured | 0 | 21 | ◯ | 15 |
| | starch | | | | |
| Example 12 | Hydroxyethylated | 0 | 9 | ◯ | 15 |
| | starch | | | | |
| Comparative | Heat denatured | 15 | 67 | ◯ | 15 |
| Example 7 | starch | | | | |
| Comparative | Heat denatured | 0 | 6 | X | 3 |
| Example 8 | starch | | | | |
| Comparative | Heat denatured | 43 | 184 | ◯ | 50 |
| Example 9 | starch | | | | |
| Comparative | Heat denatured | 5 | 91 | ◯ | 15 |
| Example 10 | starch | | | | |
| Comparative | Heat denatured | 11 | 38 | ◯ | 15 |
| Example 11 | starch | | | | |
| Comparative | Heat denatured | 6 | 33 | ◯ | 15 |
| Example 12 | starch | | | | |

As shown, Examples 7 to 12 all produced good results in terms of the number of delaminated copies, paper dust and perceived quality of print surface. Based on comparison of Example 7 and Comparative Example 7, it is clear that adding a pre-coagulated filler results in higher paper strength and less delamination or paper dust generation compared to when a filler and a processing agent are added separately. Based on comparison of Examples 7 and 8 and Comparative Examples 8 and 9, it is clear that with a clear coated printing paper, an ash content in paper of less than 5% results in poor ink impression, while an ash content in paper exceeding 40% increases the likelihood of delamination and also increases the amount of paper dust, leading to a conclusion that specifications with ash contents in these ranges are not practicable. In Comparative Example 10 where the pre-coagulated filler had a smaller particle size and the composite PAM was added by a smaller amount, delamination occurred and paper dust generated due to lower strength. From the results of Comparative Examples 11 and 12, it is clear that use of a composite PAM prepared from only the component (A) or only the component (B) provides less strength improving effect and poor offset printability.

Electronic Photograph Transfer Paper

After each of the aforementioned pre-coagulated fillers was prepared, the pre-coagulated filler was added to a material pulp slurry (LKP/DIP=70/30; cation demand: 18 μeq/l) by the amount shown in each of the following examples and comparative examples to make a base electronic photograph transfer paper with a basis weight of 64.0 g/m² using an on-top former papermaking machine operated at a speed of 1,000 m/min, after which a surface treatment agent (surface paper strength agent and/or surface sizing agent) and sodium chloride (conductive agent) were coated on both sides of the base paper to 1.5 g/m² and 0.05 g/m², respectively, using an on-machine sym sizer to obtain an electronic photograph transfer paper (Examples 13 to 17 and Comparative Examples 13 to 18). The obtained electronic photograph transfer paper was measured for breaking length, as well as the number of peeled copies, number of paper jams and amount of paper dust using a printing test conducted on a copier.

### <Measured Items>

### (1) Breaking Length: According to JIS P 8113

### (2) Evaluation Methods for Number of Paper Jams, Amount of Paper Dust and Printed Text

A Vivace 555 copier by Fuji Xerox was used to print 1,000 A4-size copies in a monochrome mode in landscape orientation at a speed of 55 copies per minute to count the number of paper jams and amount of paper dust. Printed text was evaluated visually based on the degree of transfer of toner. The evaluation results are shown in Table 1 (◯: Good, Δ: Above average, x: Bad).

### (3) Evaluation Method for Peeling

A DC135 copier by Fuji Xerox was used to print 1,000 A4-size copies in a monochrome mode in landscape orientation at a speed of 135 copies per minute to count the number of peeled copies. The evaluation results are shown in Table 3.

### Example 13

Pre-coagulated filler 2 described above was added to a material pulp slurry in the head box to make a paper stuff, and then heat denatured starch was coated as a surface treatment agent to obtain an electronic photograph transfer paper having an ash content in paper of 15%.

### Example 14

Pre-coagulated filler 2 described above was added to a material pulp slurry in the head box to make a paper stuff, and then heat denatured starch was coated as a surface treatment agent to obtain an electronic photograph transfer paper having an ash content in paper of 30%.

### Example 15

Pre-coagulated filler 1 described above was added to a material pulp slurry in the head box to make a paper stuff, and then heat denatured starch was coated as a surface treatment agent to obtain an electronic photograph transfer paper having an ash content in paper of 15%.

### Example 16

Pre-coagulated filler 4 described above was added to a material pulp slurry in the head box to make a paper stuff, and then heat denatured starch was coated as a surface treatment agent to obtain an electronic photograph transfer paper having an ash content in paper of 15%.

### Example 17

Pre-coagulated filler 3 described above was added to a material pulp slurry in the head box to make a paper stuff, and then heat denatured starch was coated as a surface treatment agent to obtain an electronic photograph transfer paper having an ash content in paper of 15%.

### Comparative Example 13

The precipitated calcium carbonate and composite PAM constituting pre-coagulated filler 2 described above were added separately to a material pulp slurry in the head box to make a paper stuff, and then heat denatured starch was coated as a surface treatment agent to obtain an electronic photograph transfer paper having an ash content in paper of 15%. The ratio of precipitated calcium carbonate and composite PAM was the same as the ratio used to prepare pre-coagulated filler 2.

### Comparative Example 14

Pre-coagulated filler 2 described above was added to a material pulp slurry in the head box to make a paper stuff, and then heat denatured starch was coated as a surface treatment agent to obtain an electronic photograph transfer paper having an ash content in paper of 2%.

### Comparative Example 15

Pre-coagulated filler 2 described above was added to a material pulp slurry in the head box to make a paper stuff, and then heat denatured starch was coated as a surface treatment agent to obtain an electronic photograph transfer paper having an ash content in paper of 50%.

### Comparative Example 16

Pre-coagulated filler 5 described above was added to a material pulp slurry in the head box to make a paper stuff, and then heat denatured starch was coated as a surface treatment agent to obtain an electronic photograph transfer paper having an ash content in paper of 15%.

### Comparative Example 17

Pre-coagulated filler 6 described above was added to a material pulp slurry in the head box to make a paper stuff, and then heat denatured starch was coated as a surface treatment agent to obtain an electronic photograph transfer paper having an ash content in paper of 15%.

### Comparative Example 18

Pre-coagulated filler 7 described above was added to a material pulp slurry in the head box to make a paper stuff, and then heat denatured starch was coated as a surface treatment agent to obtain an electronic photograph transfer paper having an ash content in paper of 15%.

TABLE 3

| | | Pre-coagulated filler | | | | | |
|---|---|---|---|---|---|---|---|
| | | | | | Processing agent | | |
| | | | | | | Ratio of | Solid weight ratio |
| | Material | Type | Particle | | Composite | (A)/(B) in | Filler/processing |
| | pulp | No. | size μm | Filler | PAM | composite PAM | agent |
| Example 13 | LKP/DIP = | 2 | 38 | Precipitated | PAM-C1 | 15/85 | 100/0.7 |
| | 70/30 | | | calcium carbonate | | | |
| Example 14 | Cation demand: | 2 | 38 | Precipitated | PAM-C1 | 15/85 | 100/0.7 |
| | 18 μeq/l | | | calcium carbonate | | | |
| Example 15 | | 1 | 27 | Ground | PAM-C1 | 15/85 | 100/0.7 |
| | | | | calcium carbonate | | | |
| Example 16 | | 4 | 41 | Precipitated | PAM-C1 | 15/85 | 100/2.5 |
| | | | | calcium carbonate | | | |
| Example 17 | | 3 | 14 | Precipitated | PAM-C1 | 15/85 | 100/0.2 |
| | | | | calcium carbonate | | | |
| Comparative | | — | — | Precipitated calcium carbonate | | 15/85 | 100/0.7 |
| Example 13 | | | | and PAM-C1 added separately | | | |
| Comparative | | 2 | 38 | Precipitated | PAM-C1 | 15/85 | 100/0.7 |
| Example 14 | | | | calcium carbonate | | | |
| Comparative | | 2 | 38 | Precipitated | PAM-C1 | 15/85 | 100/0.7 |
| Example 15 | | | | calcium carbonate | | | |
| Comparative | | 5 | 8 | Precipitated | PAM-C1 | 15/85 | 100/0.05 |
| Example 16 | | | | calcium carbonate | | | |
| Comparative | | 6 | 8 | Precipitated | PAM-C2 | 0/100 | 100/0.7 |
| Example 17 | | | | calcium carbonate | | | |
| Comparative | | 7 | 5 | Precipitated | CMC | 100/0 | 100/0.7 |
| Example 18 | | | | calcium carbonate | | | |

Copier transferability results

| | | Number of | Amount of | Number of | | |
|---|---|---|---|---|---|---|
| | Breaking | paper jams | paper dust | peeled copies | Evaluation of | Ash content in |
| | length km | Times | mg | Copies | printed text | base paper % |
| Example 13 | 6.8 | 0 | 12 | 0 | ◯ | 15 |
| Example 14 | 6.5 | 0 | 22 | 0 | ◯ | 30 |
| Example 15 | 6.9 | 0 | 16 | 0 | ◯ | 15 |
| Example 16 | 7.0 | 0 | 18 | 0 | ◯ | 15 |
| Example 17 | 6.6 | 0 | 25 | 0 | ◯ | 15 |
| Comparative | 5.9 | 7 | 55 | 10 | ◯ | 15 |
| Example 13 | | | | | | |
| Comparative | 7.5 | 0 | 5 | 0 | X | 2 |
| Example 14 | | | | | | |
| Comparative | 4.3 | Occurred | 95 | 14 | Δ | 50 |
| Example 15 | | frequently | | | | |
| Comparative | 5.6 | 14 | 34 | 3 | ◯ | 15 |
| Example 16 | | | | | | |
| Comparative | 6.1 | 5 | 47 | 0 | ◯ | 15 |
| Example 17 | | | | | | |
| Comparative | 5.8 | 0 | 50 | 4 | ◯ | 15 |
| Example 18 | | | | | | |

As shown, Examples 13 to 17 all produced good results in terms of the paper strength, number of peeled copies, number of paper jams and amount of paper dust. Based on comparison of Example 13 and Comparative Example 13, it is clear that adding a pre-coagulated filler results in higher paper strength compared to when a filler and a processing agent are added separately. The former method also eliminates paper jams due to improved paper stiffness. Based on comparison of Examples 13 and 14 and Comparative Examples 14 and 15, it is also clear that with an electronic photograph printing paper, an ash content in paper of less than 3% results in a lower evaluation of printed text, while an ash content in paper exceeding 40% increases the number of paper jams as well as amount of paper dust. In Comparative Example 16 where the pre-coagulated filler had a smaller particle size and the composite PAM was added by a smaller amount, paper jams occurred due to lower stiffness. From the results of Comparative Examples 17 and 18, it is clear that use of a composite PAM prepared from only the component (A) or only the component (B) provides less strength or stiffness improving effect and poor copyability.

### Coated Paper for Printing

A pre-coagulated filler was added to a material pulp slurry (LKP/NKP/DIP=75/15/10; cation demand: 14 μeq/l) by the amount shown in each of the following examples and comparative examples to make a base coating paper with a basis weight of 50.0 g/m² using an on-top papermaking machine operated at a speed of 1,000 m/min, after which coating solution 1 was coated on both sides of the base paper to 6 g/m² using an on-machine gate-roll coater and let dry, and then coating solution 2 was coated on both sides of the base paper to 16 g/m² using an off-machine blade coater and led dry, to obtain a coated paper for printing (Examples 18 to 22 and Comparative Examples 19 to 23). The obtained coated paper for printing was measured for the number of delaminated copies and amount of paper dust using a printing test conducted on an offer press.

### (1) Evaluation Methods for Delamination, Amount of Paper Dust and Perceived Quality of Print Surface

An offset rotary press (B2T-600 by Toshiba) was used to print 20,000 copies by the heat-set method in a color, double-sided mode with a reeling width of 880 mm and at a speed of 600 rpm to count the number of blistered copies per 100 copies. Also, the paper dust attached to the blanket cylinder was collected after the end of printing and measured as an amount per a square area of 10 cm×10 cm on the blanket cylinder. In addition, perceived quality of print surface was visually evaluated (⊚: Excellent, ◯: Good, Δ: Slightly poor, x: Poor). The evaluation results are shown in Table 4.

### (Coating Solution 1)

A pigment slurry comprising 100 parts of fine ground calcium carbonate (FMT-90 by Fimatec) was mixed with 25 parts of hydroxyethyl etherified starch (PG295 by Penford), after which water was added to obtain coating solution 1 having a solid content of 50%.

(Coating Solution 2)

100 parts of a pigment comprising 40 parts of fine kaolin (Japangloss by J. M. Huber) and 60 parts of fine ground calcium carbonate (FMT-90 by Fimatec) were mixed with sodium polyacrylate being a dispersant (by 0.2 part relative to the inorganic pigment), and the mixture was dispersed using a Serie mixer to prepare a pigment slurry with a solid content of 70%. To the obtained pigment slurry, 10 parts of styrene-butadiene copolymer latex (glass transfer temperature: 20° C., gel content: 85%) and 6 parts of hydroxyethyl etherified starch (PG295 by Penford) were added, after which water was added to obtain coating solution 2 with a solid content of 60%.

### Example 18

Pre-coagulated filler 2 described above was added to a material pulp slurry in the head box to make a paper stuff and thereby obtain a base coating paper with an ash content in paper of 15%. The obtained base coating paper was coated with coating solution 1 on both sides to 6 g/m² using a gate-roll coater and let dry, and then further coated with coating solution 2 on both sides to 16 g/m² using a blade coater and let dry, to obtain a coated paper for printing.

### Example 19

Pre-coagulated filler 2 described above was added to a material pulp slurry in the head box to make a paper stuff and thereby obtain a base coating paper with an ash content in paper of 30%. The obtained base coating paper was coated with coating solution 1 on both sides to 6 g/m² using a gate-roll coater and let dry, and then further coated with coating solution 2 on both sides to 16 g/m² using a blade coater and let dry, to obtain a coated paper for printing.

### Example 20

Pre-coagulated filler 1 described above was added to a material pulp slurry in the head box to make a paper stuff and thereby obtain a base coating paper with a filler content in paper of 15%. The obtained base coating paper was coated with coating solution 1 on both sides to 6 g/m² using a gate-roll coater and let dry, and then further coated with coating solution 2 on both sides to 16 g/m² using a blade coater and let dry, to obtain a coated paper for printing.

### Example 21

Pre-coagulated filler 4 described above was added to a material pulp slurry in the head box to make a paper stuff and thereby obtain a base coating paper with an ash content in paper of 15%. The obtained base coating paper was coated with coating solution 1 on both sides to 6 g/m² using a gate-roll coater and let dry, and then further coated with coating solution 2 on both sides to 16 g/m² using a blade coater and let dry, to obtain a coated paper for printing.

### Example 22

Pre-coagulated filler 3 described above was added to a material pulp slurry in the head box to make a paper stuff and thereby obtain a base coating paper with an ash content in paper of 15%. The obtained base coating paper was coated with coating solution 1 on both sides to 6 g/m² using a gate-roll coater and let dry, and then further coated with coating solution 2 on both sides to 16 g/m² using a blade coater and let dry, to obtain a coated paper for printing.

### Comparative Example 19

The precipitated calcium carbonate and composite PAM constituting pre-coagulated filler 2 described above were added separately to a material pulp slurry in the head box to make a paper stuff and thereby obtain a base coating paper with an ash content in paper of 15%. The obtained base coating paper was coated with coating solution 1 on both sides to 6 g/m² using a gate-roll coater and let dry, and then further coated with coating solution 2 on both sides to 16 g/m² using a blade coater and let dry, to obtain a coated paper for printing. The ratio of precipitated calcium carbonate and composite PAM was the same as the ratio used to prepare pre-coagulated filler 2.

### Comparative Example 20

Pre-coagulated filler 2 described above was added to a material pulp slurry in the head box to make a paper stuff and thereby obtain a base coating paper with an ash content in paper of 2%. The obtained base coating paper was coated with coating solution 1 on both sides to 6 g/m² using a gate-roll coater and let dry, and then further coated with coating solution 2 on both sides to 16 g/m² using a blade coater and let dry, to obtain a coated paper for printing.

### Comparative Example 21

Pre-coagulated filler 2 described above was added to a material pulp slurry in the head box to make a paper stuff and thereby obtain a base coating paper with an ash content in paper of 50%. The obtained base coating paper was coated with coating solution 1 on both sides to 6 g/m² using a gate-roll coater and let dry, and then further coated with coating solution 2 on both sides to 16 g/m² using a blade coater and let dry, to obtain a coated paper for printing.

### Comparative Example 22

Pre-coagulated filler 6 described above was added to a material pulp slurry in the head box to make a paper stuff and thereby obtain a base coating paper with an ash content in paper of 15%. The obtained base coating paper was coated with coating solution 1 on both sides to 6 g/m² using a gate-roll coater and let dry, and then further coated with coating solution 2 on both sides to 16 g/m² using a blade coater and let dry, to obtain a coated paper for printing.

### Comparative Example 23

Pre-coagulated filler 7 described above was added to a material pulp slurry in the head box to make a paper stuff and thereby obtain a base coating paper with an ash content in paper of 15%. The obtained base coating paper was coated with coating solution 1 on both sides to 6 g/m² using a gate-roll coater and let dry, and then further coated with coating solution 2 on both sides to 16 g/m² using a blade coater and let dry, to obtain a coated paper for printing.

TABLE 4

| | | Pre-coagulated filler | | | | | |
|---|---|---|---|---|---|---|---|
| | | | | | Processing agent | | |
| | | | | | | Ratio of | Solid weight ratio |
| | Material | Type | Particle | | Composite | (A)/(B) in | Filler/processing |
| | pulp | No. | size μm | Filler | PAM | composite PAM | agent |
| Example 18 | IKP/DIP = | 2 | 38 | Precipitated | PAM-C1 | 15/85 | 100/0.7 |
| | 70/30 | | | calcium carbonate | | | |
| Example 19 | Cation demand: | 2 | 38 | Precipitated | PAM-C1 | 15/85 | 100/0.7 |
| | 18 μeq/l | | | calcium carbonate | | | |
| Example 20 | | 1 | 27 | Ground | PAM-C1 | 15/85 | 100/0.7 |
| | | | | calcium carbonate | | | |
| Example 21 | | 4 | 41 | Precipitated | PAM-C1 | 15/85 | 100/2.5 |
| | | | | calcium carbonate | | | |
| Example 22 | | 3 | 14 | Precipitated | PAM-C1 | 15/85 | 100/0.2 |
| | | | | calcium carbonate | | | |
| Comparative | | — | — | Precipitated calcium carbonate | | 15/85 | 100/0.7 |
| Example 19 | | | | and PAM-C1 added separately | | | |
| Comparative | | 2 | 38 | Precipitated | PAM-C1 | 15/85 | 100/0.7 |
| Example 20 | | | | calcium carbonate | | | |
| Comparative | | 2 | 38 | Precipitated | PAM-C1 | 15/85 | 100/0.7 |
| Example 21 | | | | calcium carbonate | | | |
| Comparative | | 6 | 8 | Precipitated | PAM-C2 | 0/100 | 100/0.7 |
| Example 22 | | | | calcium carbonate | | | |
| Comparative | | 7 | 5 | Precipitated | CMC | 100/0 | 100/0.7 |
| Example 23 | | | | calcium carbonate | | | |

| | Pre-coagulated filler | | | |
|---|---|---|---|---|
| | Number of | Amount of | | |
| | blistered copies | paper dust | Evaluation of | Ash content in |
| | Copies per 100 | mg/100 cm² | print surface | base paper % |
| Example 18 | 0 | 15 | ◯ | 15 |
| Example 19 | 0 | 24 | ⊚ | 30 |
| Example 20 | 0 | 15 | ◯ | 15 |
| Example 21 | 0 | 22 | ⊚ | 15 |
| Example 22 | 0 | 39 | ◯ | 15 |
| Comparative | 13 | 87 | ◯ | 15 |
| Example 19 | | | | |
| Comparative | 0 | 7 | Δ | 2 |
| Example 20 | | | | |
| Comparative | 75 | 195 | ◯ | 50 |
| Example 21 | | | | |
| Comparative | 10 | 51 | ◯ | 15 |
| Example 22 | | | | |
| Comparative | 8 | 48 | ◯ | 15 |
| Example 23 | | | | |

When the results of Examples and Comparative Examples are examined, it is shown that Examples 18 to 22 all produced good results in terms of the number of delaminated copies, paper dust and perceived quality of print surface. Based on comparison of Example 18 and Comparative Example 19, it is clear that adding a pre-coagulated filler results in improved paper strength and blistering resistance compared to when a filler and a processing agent are added separately. Based on comparison of Examples 18 and 19 and Comparative Examples 20 and 21, it is clear that with a coated paper for printing, an ash content in paper of less than 3% results in higher strike-through and lower smoothness, thus leading to poor print surface. On the other hand, an ash content in paper exceeding 40% results in more paper dust. These results lead to a conclusion that specifications with ash contents in these ranges are not practicable. From the results of Comparative Examples 22 and 23, it is clear that use of a composite PAM prepared from only the component (A) or only the component (B) provides less strength improving effect and poor printability.

### INDUSTRIAL FIELD OF APPLICATION

By using as a base paper a paper containing pre-coagulated filler conforming to the present invention, a paper offering good stiffness and strength as well as high smoothness can be achieved. For example, a newsprint paper, clear coated printing paper, electronic photograph transfer paper or coated paper for printing, among others, can be provided that produces less delamination, tearing, paper dust, blistering and other problems, and also offers excellent print quality when used in offset printing, or eliminates paper jam or peeling and generates less paper dust while being transferred through a copier during copying.

1: A paper characterized by having a base paper having an ash content in paper of 3 to 40 percent by solid weight and containing a pre-coagulated filler having an average particle size of 10 to 80 μm as measured by the laser diffraction method, wherein said filler has been processed using a composite acrylamide copolymer produced by forming a complex of (A) an anionic polysaccharide and (B) a cationic and/or amphoteric acrylamide copolymer.

2: The paper according to claim 1, characterized in that said paper is a neutral newsprint paper for offset printing having a surface treatment agent coated over the base paper.

3: The paper according to claim 1, characterized in that said paper is a clear coated printing paper having a surface treatment agent coated over the base paper.

4: The paper according to claim 1, characterized in that said paper is an electronic photograph transfer paper.

5: The paper according to claim 1, characterized in that said paper is a coated printing paper having a coating layer containing pigment and adhesive provided on the base paper.

6: The paper according to claim 1, characterized in that the weight ratio of the component (A) and component (B) is in a range of A/B=2/98 to 45/55.

7: The paper according to claim 1, characterized in that the added amount of the composite acrylamide copolymer comprising the component (A) and component (B) is in a range of 0.1 to 3.0 percent by solid weight relative to the filler.

8: The paper according to claim 1, characterized in that the filler is calcium carbonate.

9: The paper according to claim 2, characterized in that the surface treatment agent is hydroxyethylated starch.

10: The paper according to claim 3, characterized in that the surface treatment agent is hydroxyethylated starch.

11: The paper according to claim 2, characterized in that its basis weight is in a range of 37 to 52 g/m².

12: The paper according to claim 5, characterized in that its density is in a range of 0.4 to 1.3 g/cm³.

13: A method of manufacturing a paper characterized by comprising: a step of preparing a pre-coagulated filler having an average particle size of 10 to 80 μm as measured by the laser diffraction method, wherein said filler has been processed using a composite acrylamide copolymer produced by forming a complex of (A) an anionic polysaccharide and (B) a cationic and/or amphoteric acrylamide copolymer; and a step of adding the pre-coagulated filler to a paper stuff containing pulp to make a paper having an ash content in paper of 3 to 40 percent by solid weight.

14: The manufacturing method according to claim 13, characterized in that the step to prepare a pre-coagulated filler further comprises: a step to mix the component (A) and component (B) in a water matrix to form a composite acrylamide copolymer; and a step to mix the composite acrylamide copolymer with the filler in a water matrix to form the pre-coagulated filler.

15: The manufacturing method according to claim 13, characterized in that the weight ratio of the component (A) and component (B) in the composite acrylamide copolymer is in a range of A/B=2/98 to 45/55.

16: The manufacturing method according to claim 13, characterized in that the composite acrylamide copolymer is added by a range of 0.1 to 3.0 percent by solid weight relative to the filler.
